(19) United States
(12) Patent Application Publication
(10) Pub. No.: US 2026/0076391 A1
(43) Pub. Date: Mar. 19, 2026

(54) PROCESS FOR THE PREPARATION OF PARTICULARLY HARD CHEWING GUM

(71) Applicant: Tomas Palomaki, Helsinki (FI)

(72) Inventor: Tomas Palomaki, Helsinki (FI)

(21) Appl. No.: 18/889,448

(22) Filed: Sep. 19, 2024

(51) Int. Cl. A23G 4/04; A23G 4/02; A23G 4/08; A23G 4/12; A23G 4/20

(52) U.S. Cl. CPC A23G 4/04; A23G 4/025; A23G 4/08; A23G 4/126; A23G 4/20

(57) ABSTRACT

According to an aspect of the present invention, there is provided a method for processing a hard gum base, comprising: humidifying or heat treating the hard gum base before an extrusion or cutting stage, wherein the humidification or heat treatment to reduce the hardness of the gum composition; and putting the gum base into a heated or humidified state in a short enough time before the extrusion or cutting happens so that the gum is in a softer state than it otherwise would be.

### BACKGROUND

This invention relates in general to the preparation of chewing gum and, in particular, to a new and useful method of preparing chewing gum wherein a chewing gum composition is of a particularly hard material. Production of such chewing gum is made difficult by the hardness which causes a number of manufacturing issues known in the art.

### SUMMARY OF INVENTION

Therefore, the present invention provides an improved method for production of chewing gum with a particularly hard base material. This invention focuses on methods for improving the processing and manufacturing of chewing gum with harder compositions that are traditionally more difficult to extrude, cut, or shape using standard manufacturing machinery. By utilizing a novel approach involving humidification and/or heat treatment at specific stages of production, this invention provides a solution to overcome the challenges of processing harder gum compositions.

According to an aspect of the present invention, there is provided a method for processing a hard gum base, comprising: humidifying or heat treating the hard gum base before an extrusion or cutting stage, wherein the humidification or heat treatment to reduce the hardness of the gum composition; and putting the gum base into a heated or humidified state in a short enough time before the extrusion or cutting happens so that the gum is in a softer state than it otherwise would be.

### BRIEF DESCRIPTION OF THE DRAWINGS

FIG. 1 illustrates a flow chart for an exemplary process according to an embodiment of the present invention (although other process sequences can be used in other embodiments).

### DETAILED DESCRIPTION

Prior art describes forming systems configured to continuously receive chewing gum base material from the forming system at an entry point of a manufacturing device, and a multi-pass conveying system configured to continuously transport the gum from the entry point to an exit point of the machinery, the forming system being configured to form the gum to be in a condition for stacking or collecting upon exiting the exit point of the manufacturing device.

In the traditional gum manufacturing process, ingredients such as gum base, sweeteners, softeners, flavorings, and colorants are mixed together to form a homogenous mixture. After the mixing process, the gum mass is typically passed through an extruder, where it is shaped into the desired form. Then the gum mass is cut into shapes such as sticks, cubes, or balls. However, for gum compositions that are formulated to be harder and more durable, the extrusion and shaping processes present significant challenges. Harder gum compositions tend to be stiffer and more difficult to manipulate, causing strain on manufacturing equipment and leading to inconsistencies in product quality.

Over the years, various attempts have been made to address these challenges. Some solutions have involved altering the formulation of the gum itself, such as by adjusting the ratios of gum base to softeners or by incorporating additional ingredients to improve pliability. While these approaches have had some success, they often result in a compromise in the final product's texture, flavor, or overall consumer experience. Additionally, altering the formulation can limit the range of possible gum compositions, restricting the diversity of gum products that can be offered in the market.

Extruders and cutting machines typically cannot be easily adapted to apply greater force to the gum during processing. These modifications can be costly and may not be feasible for smaller production facilities. Furthermore, the increased mechanical strain on the equipment can lead to increased wear and tear, reducing the longevity of the machines and increasing maintenance costs.

The present invention enables the efficient processing of harder gum compositions without compromising product quality or placing excessive strain on manufacturing equipment. The present invention addresses this need by introducing a humidification and/or heat treatment step prior to the extrusion and cutting stages. This treatment softens the gum, making it more pliable and easier to process, while preserving the desired hardness and texture of the final product.

In the present invention, chewing gum is softened before putting it through machinery that makes it into the shape it is, i.e., extrusion machinery first, then cutting machinery. Since the gum base is very hard material, it does not go through manufacturing machinery easily. Thus, the present invention utilizes a method in which the gum base is softened before it goes through the manufacturing machinery. In the present invention, the softening can be done by humidifying the gum material or heating it.

The method involves applying a humidification and/or heat treatment step after the gum has been mixed but before it undergoes extrusion or cutting. This treatment step is critical in making the gum pliable enough for efficient processing by machinery, reducing the mechanical strain on the equipment and ensuring a consistent, high-quality product.

In one embodiment, the humidification treatment involves passing the gum through a controlled chamber where the ambient humidity is precisely regulated to introduce a specific amount of moisture into the gum mass. This added moisture temporarily softens the gum, making it easier to manipulate during extrusion and shaping. After the shaping process, the moisture content can be allowed to evaporate or be actively removed, allowing the gum to return to its original hardness.

In another embodiment, the heat treatment involves passing the gum through a heated chamber or tunnel, where the temperature is carefully controlled to soften the gum without affecting its flavor or texture. The heat makes the gum more malleable, allowing it to be extruded and shaped with less force, reducing wear and tear on the machinery. After the gum is shaped, it can be cooled to return it to its desired hardness.

In yet another embodiment, heat is provided in a gum mixer, wherein the gum base gets passed to extruder or cutting machine quickly before the gum gets to cool down significantly. In yet another embodiment, the extruder machine(s) or cutter machine(s) apply heat.

This method can be applied to a wide range of gum compositions, including those with high levels of gum base or other hardening agents as well as nutritional supplements such as vitamins (e.g., vitamins D and K). It enables manufacturers to produce gum with more diverse textures and properties, expanding the range of gum products available to consumers. Additionally, the method is cost-effective, as it does not require significant modifications to existing equipment and can be implemented in both large-scale and small-scale production facilities.

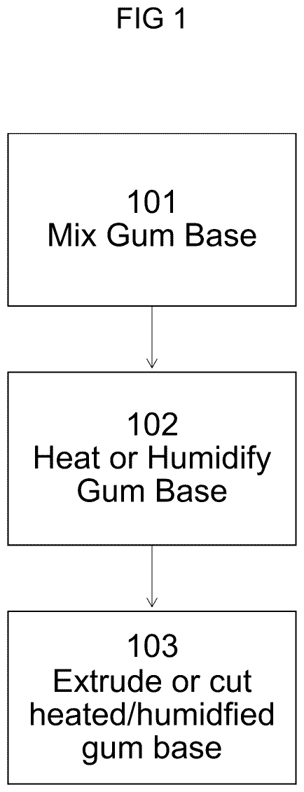

FIG. 1 illustrates a flow chart for a process according to an embodiment of the present invention.

Step 101 is to mix gum base. Rubber used in gum base includes but is not limited to Polyisobutylene, Isobutylene-isoprene Copolymer, Natural Rubber, Polyvinyl Acetate, Polyethylene, Chicle, Polyisoprene, Synthetic Polyisoprene, Polyurethane Rubber, Polychloroprene, Ethylene-Vinyl Acetate, Acrylonitrile-Butadiene Rubber, and Silicone Rubber.

Shore hardness is a measure of a particular material's resistance to penetration or indentation. Gum base according to the present invention may have a high Shore hardness.

Gum produced according to embodiments of the present invention may also contain essential vitamins, such as vitamin D3 and K2, which are commonly lacking in Western diets. These vitamins play a synergistic role in promoting bone remodeling, improving bone density and health. Vitamin D3 is crucial for calcium absorption, while K2 ensures that calcium is directed to bones rather than soft tissues. Additionally, these vitamins support cardiovascular health and immune function.

One of the unique aspects of gum produced in this way is that, unlike traditional vitamin capsules, the vitamins in the gum are absorbed directly through the mouth tissue. This sublingual absorption method is more efficient than traditional digestion, allowing for a higher rate of vitamin absorption into the bloodstream. Studies have shown that absorption through the mucous membranes in the mouth bypasses the digestive system, allowing for quicker and more effective delivery of the nutrients.

Ingredients of gum produced according to the present invention can include Xylitol, Sorbitol, Gum Base, D-Mannitol, Maltitol, Natural and Artificial Flavors, Glycerin, Soy Lecithin, Aspartame, Acesulfame-K, Vitamin D3, Vitamin K2, BHT (to maintain freshness).

Step 102 is to heat or humidify the gum base. In one embodiment, the humidification treatment is applied to the gum mass after it has been mixed with the necessary ingredients, such as gum base, sweeteners, softeners, and flavorings. The mixed gum is transferred to a controlled humidification chamber, where the ambient humidity is carefully regulated. The chamber introduces moisture into the gum at a rate that softens the gum without causing it to become sticky or overly wet. This moisture makes the gum more pliable, allowing it to be easily extruded through the shaping machinery.

The humidification chamber can be designed to operate at various humidity levels, depending on the Shore hardness of the gum.

The heating or humidification can happen during mixing as well, but then the heat/humidification is maintained for the extrusion or cutting.

The specific composition of the gum being processed varies. For example, for harder gum compositions with a high gum base content, a higher humidity level may be required to achieve the desired level of pliability. Conversely, for softer gum compositions, a lower humidity level may be sufficient. The duration of the treatment can also be adjusted to ensure that the gum receives the optimal amount of moisture.

In another embodiment, the heat treatment is applied to the gum mass after mixing but before extrusion or cutting. The gum is passed through a heated tunnel or chamber, where the temperature is carefully controlled to soften the gum. The heat treatment can be applied at various stages of the process, depending on the desired properties of the final product. For example, heat can be applied immediately before the gum enters the extruder, ensuring that the gum is soft enough to be shaped without placing excessive strain on the machinery.

The heat treatment can be adjusted based on the composition of the gum and the desired texture of the final product. For harder gum compositions, a higher temperature may be required to achieve the necessary level of pliability. The temperature and duration of the heat treatment can be fine-tuned to ensure that the gum is softened just enough for extrusion without affecting its flavor or causing any degradation of the ingredients.

Step 103 illustrates that once the gum has been treated with either humidification or heat, it is passed through an extruder, where it is shaped into the desired form. The extrusion process can be used to create a wide variety of gum shapes, including sticks, cubes, balls, and other novelty shapes. After extrusion, the gum is cut into individual pieces using a cutting machine. The cutting process is significantly easier when the gum has been treated with humidification or heat, as the gum is more pliable and less likely to cause strain on the cutting blades.

In various embodiment, the treatment can happen either before extrusion process or before cutting process, as in some embodiments gum doesn't go through an extruder.

In embodiments of the present invention, gum base may be humidified or heat treated before a machine blends, smooths or forms the gum into sheets or cuts the gum into shape. The effects of the humidification or heat treatment impact the ability for the machine to perform these actions.

A variety of gum shapes may be produced according to embodiment of the present invention, including but not limited to sticks and pellets.

Step 104 is an optional step of applying an outer coating of sweeteners and/or flavor. Flavors include for example (but are not limited to) mint, strawberry, and watermelon.

The illustrations of embodiments described herein are intended to provide a general understanding of the structure of various embodiments, and they are not intended to serve as a complete description of all the elements and features of apparatus and systems that might make use of the structures described herein. Many other embodiments will be apparent to those of skill in the art upon reviewing the above description. Other embodiments may be utilized and derived therefrom, such that structural and logical substitutions and changes may be made without departing from the scope of this disclosure. Figures are also merely representational and may not be drawn to scale. Certain proportions thereof may be exaggerated, while others may be minimized. Accordingly, the specification and drawings are to be regarded in an illustrative rather than a restrictive sense. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description. Therefore, it is intended that the disclosure not be limited to the particular embodiment(s) disclosed.

What is claimed is:

1. A method for processing a hard gum base, comprising:
humidifying or heat treating the hard gum base before an extrusion or cutting stage, wherein the humidification or heat treatment to reduce the hardness of the gum composition; and
putting the gum base into a heated or humidified state in a short enough time before the extrusion or cutting happens so that the gum is in a softer state than it otherwise would be.

2. The method of claim 1, wherein the humidification step involves passing the gum through a controlled moisture chamber.

3. The method of claim 1, wherein the heat treatment involves passing the gum through a heated tunnel before extrusion or cutting.

4. The method of claim 1, wherein the gum base contains one or more vitamins.

5. The method of claim 4, wherein the one or more vitamins are one or more of Vitamin D and Vitamin K.

6. The method of claim 1, wherein the gum base is heated or humidified after mixing.

7. The method of claim 1, further comprising applying an outer coating of an outer coating of one or more of sweeteners and flavor after extrusion or cutting.

8. The method of claim 1, wherein a gum mixer heats the gum base and the gum base gets passed to extruder or cutting machine quickly before the gum gets to cool down significantly.
